(19) United States
(12) Patent Application Publication
(10) Pub. No.: US 2007/0163968 A1
(43) Pub. Date: Jul. 19, 2007

(54) Method and apparatus for providing treatment chemicals to process water systems

(75) Inventors: Lyle H. Steimel, Forest Park, OH (US); James C. Emerson, Cincinnati, OH (US)

Correspondence Address: WOOD, HERRON & EVANS, LLP, 2700 CAREW TOWER, 441 VINE STREET, CINCINNATI, OH, 45202, US

(73) Assignee: JohnsonDiversey, Inc., Sturtevant, WI (US)

(21) Appl. No.: 11/332,941

(22) Filed: Jan. 17, 2006

(51) Int. Cl. C02F 1/68

(52) U.S. Cl. 210/749; 210/206

(57) ABSTRACT

Forward osmosis is utilized to dispense chemicals into a process water system such as a cooling tower, chilled water system, boiler, or pulp and paper plant. The dispenser includes a flexible pouch filled with treatment chemicals and an osmotic membrane. The dispenser is placed in the process water system. Water passing through the membrane increases internal pressure, which forces chemical into the process water system. The exposed surface area of the osmotic membrane can be altered to control dispensing rate. The apparatus can either utilize the chemical treatment agent as the osmotic agent, or can be divided into two separate areas utilizing a separate osmotic agent such as sodium chloride. The dispenser can be positioned in the process water system at a location where water flows onto the osmotic membrane only when the process water system is in operation.

### BACKGROUND OF THE INVENTION

Process water systems include a variety of different apparatus. These include heating and cooling apparatus, such as water cooling towers, chilled water systems, and closed waters systems such as boilers. Other process water systems are processing plants, such as pulp and paper processing plants. Many of these systems are recirculating water systems and others are once-through systems.

All process water systems generally require the addition of some treatment chemical for proper operation. For example, cooling towers and other open recirculating water systems require chemicals to prevent scale formation, prevent micro-organism formation, sludge reduction and corrosion prevention. Compounds typically added to a cooling tower include quaternary ammonium salts, chlorine dioxide, reducing agents such as chlorinated isocyanurates, hypochlorite, hydantoins, and the like. Corrosion inhibitors typically used in such systems include water soluble polymers, phosphates, molybdates, sulfates, and the like. Closed water systems, such as boilers, and the like, require oxygen scavengers. Hardness sequestering agents include chelants, such as ethylene diamine tetraacetic acid and nitrilotriacetic acid. There are also all-in-one treatment compositions such as the ones used for cooling towers as disclosed in Coughlin U.S. Pat. No. 5,800,732, and those used for boiler water treatment as disclosed in Steimel et al., U.S. Pat. No. 4,874,541.

Generally, these systems require some apparatus to dispense the chemical into the process water system. There are a wide variety of such apparatus which can be, for example, time-operated pumps or more complex computerized operated systems.

### SUMMARY OF THE INVENTION

The present invention is premised on the realization that an inexpensive device that does not require mechanical pumps or the like, can be employed to dispense treatment chemicals into a process water system.

More particularly, the present invention is premised on the realization that such a device that utilizes forward osmosis can be used to dispense chemicals. Such a system would include a container of treatment chemicals and a forward osmosis membrane. Forward osmosis is used to draw liquid into the container to force the treatment chemical out of the container into the process water system. The dispensing apparatus can use the treatment chemical to draw water through the membrane or a separate salt can be used. In the latter case, the treatment chemical will generally be a liquid held in a separate compressible portion of the container.

In a further embodiment of the present invention, the apparatus can be located in a position where water from the process water system is applied on the forward osmosis membrane only when the process water system is operational. For example, this may be on the side wall of a cooling tower where the water from the cooling tower flows over the forward osmosis membrane.

The objects and advantages of the present invention will be further appreciated in light of the following detailed description and drawings, in which:

### BRIEF DESCRIPTION OF THE DRAWINGS

FIG. 1 is a perspective view, partially broken away, of the apparatus used in the present invention;

FIG. 2 is a cross sectional view, partially broken away, taken at line 2-2 of FIG. 1;

FIG. 3 is a perspective view of an alternate embodiment of the present invention;

FIG. 4A is a cross sectional view taken at line 4A-4A of FIG. 3 with a sheet covering the forward osmosis membrane being removed;

FIG. 4B is a cross sectional view similar to FIG. 4A diagrammatically showing the ingress of water into the apparatus shown in FIG. 3;

FIG. 5 is a perspective view of an alternate embodiment of the present invention;

FIG. 6A is a cross sectional view taken at line 6A-6A of FIG. 5 showing the protective covering over the forward osmosis membrane being removed;

FIG. 6B is a cross sectional view similar to FIG. 6A diagrammatically showing the ingress of water into the forward osmosis membrane; and

FIG. 7 is a diagrammatic view of a process water system utilizing the present invention.

### DETAILED DESCRIPTION

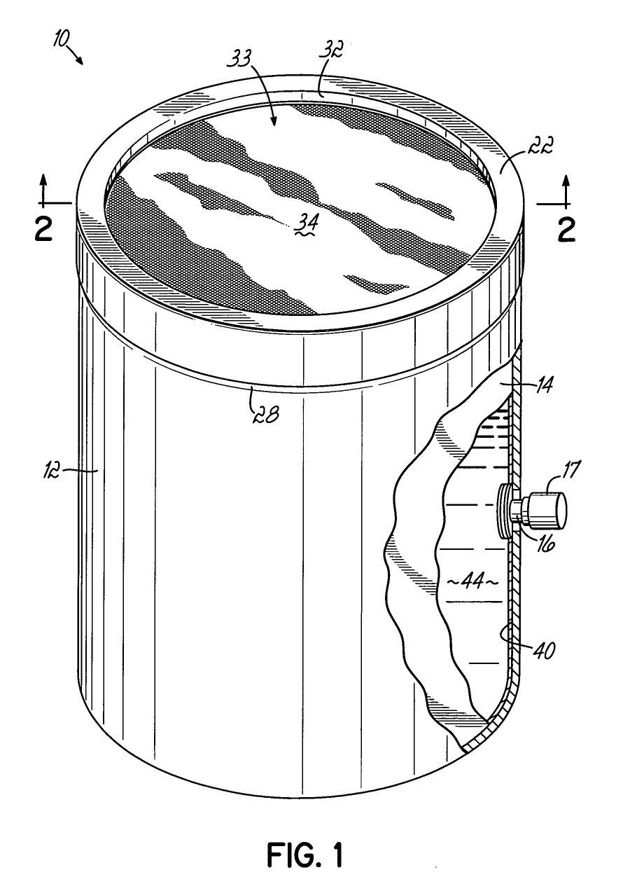

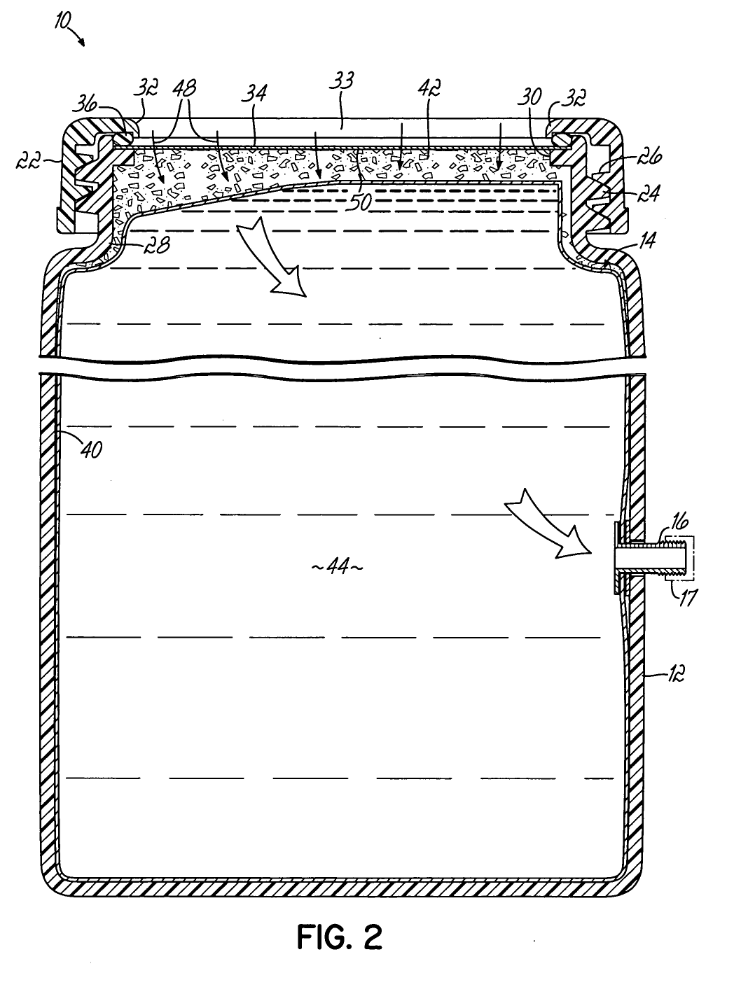

As shown in FIG. 1, the present invention is a dispensing apparatus 10 for dispensing chemical treatment compositions. The apparatus shown in FIG. 1 is designed to dispense liquid treatment chemicals. As previously discussed, these can be a wide range of different chemical compositions, either liquids, or solids dissolved in liquids, which are used for treatment of water in process water systems.

The dispensing apparatus 10 had a rigid outer wall 12, preferably formed of a polymer such as polypropylene, or the like, and an inner pouch 14 made of a flexible polymeric material such as polyethylene, or the like. A dispensing port 16 connects to the inner flexible pouch 14 and extends through side wall 12 of the dispensing apparatus 10. Port 16 includes a one-way valve (not shown) and a removable cap 17. The pouch 14 is sealed so that liquid can only flow through part 17. The dispensing apparatus 10 includes a lid 22 having internal threads 24 which engage the external threads 26 on the neck 28 of the dispensing apparatus 10. The neck 28 includes an inwardly extended annular lip 30, and the lid has an inwardly extended rim 32, leaving a large circular opening 33. A forward osmosis membrane 34 is trapped between the lip 30 of neck 26 and rim 32 of lid 22 with an O-ring 36 forming a seal between the containiner and the membrane 34.

For use in the present invention, the forward osmosis membrane can be purchased. A suitable source of the membrane is Osmotek, Inc. of Corvallis, Oreg., although other sources can be employed.

The interior 40 of dispensing apparatus 10 includes the sealed flexible pouch 14 and a water soluble salt 42 between membrane 34 and pouch 14. Any innocuous water soluble salt can be used. Preferably, the salt is sodium chloride. The salt 42 is located immediately adjacent the inner surface 50 of the forward osmosis membrane 34. Pouch 12 is filled with the liquid treatment agent 44. Exemplary liquid treatment compositions include those disclosed in U.S. Pat. No. 5,800,732 and U.S. Pat. No. 4,874,541.

To use the dispensing apparatus, cap 17 is removed and the apparatus 10 is placed in contact with water in a process water system. Specifically, the membrane 34 must be in contact with water. When the water contacts the membrane 34, the water is drawn through the membrane, dissolving salt. Water which passes through the membrane presses against the inner flexible pouch 14, as shown by arrows 48.

As water continues to pass through the membrane 34, the pressures indicated by arrows 48 will increase which will, in turn, constrict the flexible pouch 14, forcing liquid through the dispensing valve 16 into the process water system. This will continue until the unit is full of water dissolved in the salt and the inner flexible pouch 14 is empty.

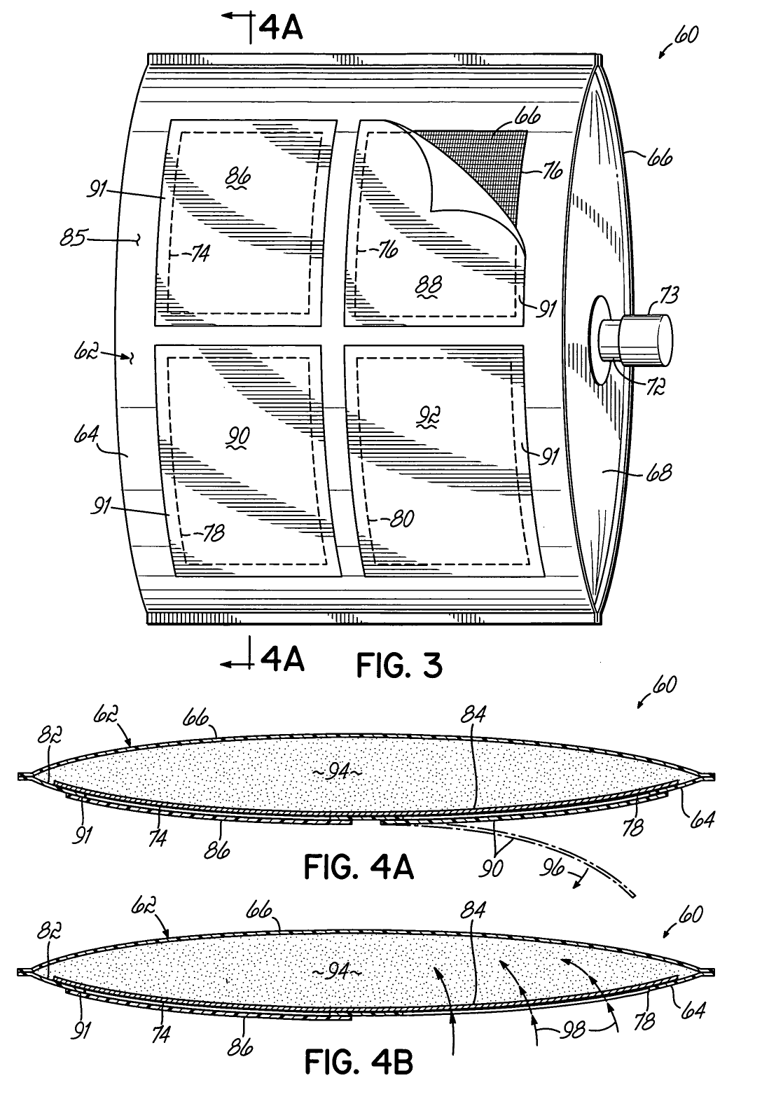

FIG. 3 shows an alternate embodiment in which the treatment agent acts as the osmotic agent drawing water into the pouch. This embodiment uses a single pouch dispensing apparatus 60 having an outer flexible wall 62. The outer flexible wall 62 is formed from a first sheet 64 and second sheet 66, and gusseted top panel 68 and bottom panel(not shown). These are heat welded together to form a sealed pouch. Fixed to top panel 68 is a one-way valve port 72, with a cap 73.

The first sheet 64 includes four windows 74,76,78,80. Fixed to an inner surface 82 of first sheet 64 behind window 74-80 is a forward osmosis membrane 84. Membrane 84 is adhered or heat sealed to the inner surface 82 of sheet 64. Four removable cover sheets 86-92 cover windows 74-80, respectively. These can be applied to the outer surface 85 of sheet 64 with a pressure sensitive adhesive, or can-be part of first sheet 62 with perforations which will facilitate their removal. As shown in FIG. 3, cover sheets 86-92 are bonded around the peripheral edges 91 to surface 85 with pressure sensitive adhesive (not shown). The interior of pouch 60 is filled with a solid or concentrated liquid treatment agent 94. Preferably, this will be a solid material containing water soluble salts. A variety of exemplary treatment agents are disclosed in U.S. Pat. No. 5,800,732 and U.S. Pat. No. 4,874,541, the disclosures of which are hereby incorporated by reference.

To dispense treatment chemical, cap 73 is removed. One or more of the covers 86-92 are removed to expose one or more windows 74-80, as shown by arrow 96. Exposing more surface area of the forward osmosis membrane to water increases the rate at which water passes through the osmotic membrane. This increases the rate at which the treatment chemical is dispensed.

The pouch 60 is placed somewhere in the process water system in contact with water. Water passes through the exposed membrane, as shown by arrow 98. This will increase pressure within pouch 60. That pressure will force the dissolved treatment chemical through port 72 into the process water. This will continue until the vast majority of the treatment chemical has been forced from the pouch 60, and the water remaining within the pouch is a relatively dilute solution of the treatment composition. The pouch remains in the process water for a defined period of time. Based on the number of windows removed, the pouch will be replaced when a pre-determined time has passed.

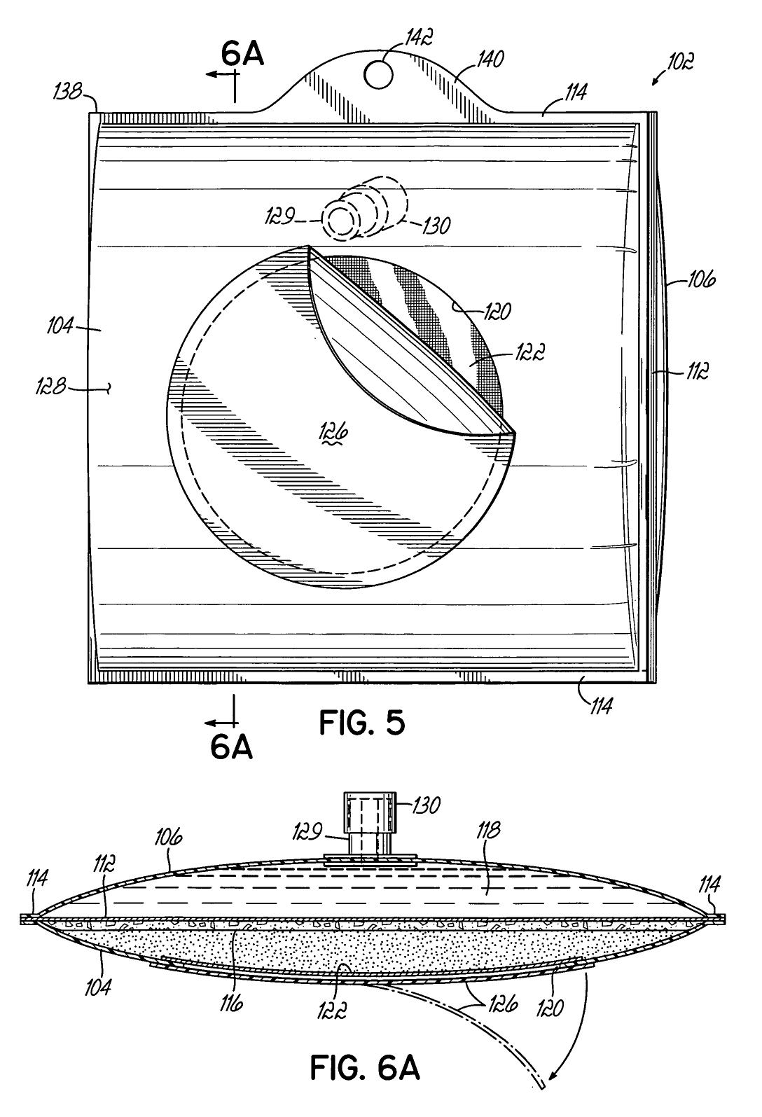

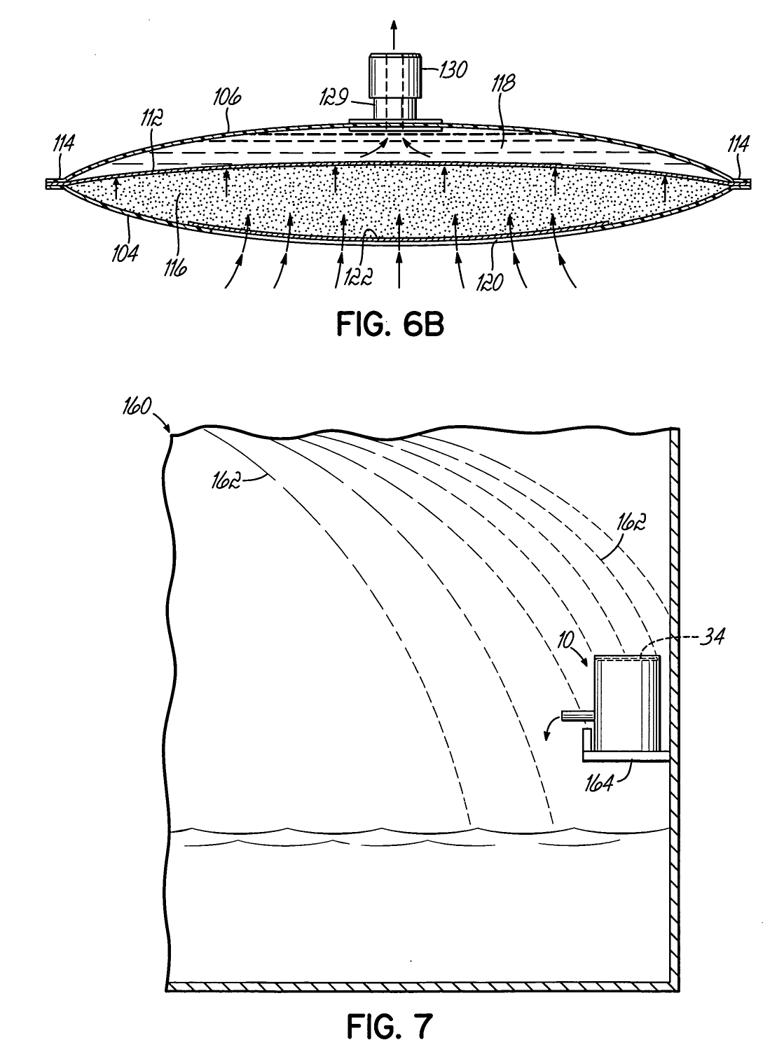

A second alternate embodiment is shown in FIGS. 5, 6A and 6B. In this embodiment, a flexible dispensing pouch 102 is formed from a first flexible sheet 104 and second flexible sheet 106. Sandwiched between the first sheet 104 and second sheet 106 is an inner panel 112. A peripheral heat seal 114 binds the first sheet to the second sheet 100, separated by the inner panel 112. The inner panel 112 forms first and second sealed areas 116 and 118. Opening 120 extends through the first sheet 104 and is covered by osmotic membrane 122. A cover member 126 is removably attached to the exterior 128 of first sheet 104 covering the opening 120. A one-way valve port 129 is attached to the second sheet 106 and is closed with a cap 130 which can be removed to allow liquid to pass through the one-way valve port 129.

A water soluble salt 134, preferably sodium chloride, is located between sheet 104 and panel 112. Liquid treatment chemical 136 fills the area 118 between panel 112 and sheet 106. The top edge 138 of pouch 102 includes a tab 140 with a hole 142 which permits the pouch to be supported on a peg or hook.

For use in the present invention, the cover 126 is removed, exposing osmotic membrane 122. Cap 130 is removed and the pouch 102 is placed in the process water system. The pouch can be supported by tab 140. As water passes through osmotic membrane 122, the salt dissolves and forces panel 112 toward second sheet 106. This increases the pressure within area 118, forcing chemical through the valve port 129, as best shown in FIG. 6B.

In this embodiment, a single cover sheet is shown with a single opening. However, this embodiment can also utilize the same opening structure shown in FIG. 3.

The present invention can be used in a wide variety of manners. For example, the dispensing apparatus can simply be submerged in water in the process water system. Alternately, the osmotic membrane can be positioned so that it is contacted with water only when the process water system is in operation. This can be done by placing apparatus in a side stream where water flows onto the osmotic membrane only when the system is in operation. Or, as shown in FIG. 7, the dispensing apparatus 10 can be supported, for example, in a cooling tower 160 in a location where a spray of water 162 contacts the osmotic membrane 40. When the cooling tower 160 is not in operation, the spray of water 162 will not flow, and no chemical will be dispensed. As shown in FIG. 7, the apparatus 10 shown in FIG. 1 is simply supported on a shelf 164. Alternately, for example, the product shown in FIG. 5 can be supported from tab 140. The dispenser can also be supported in a pool of water where the height of the pool increases during operation so that when the process water system is not in operation, the water level is lower and does not contact the osmotic membrane.

As discussed, a wide variety of different treatment compositions can be used in the present invention can be. A single dispenser having an all-in-one composition can be used. Alternately, multiple, separate osmotically controlled pouches can be placed in the same water system each filled with a different treatment chemical or mixture of chemicals. This will enable one to tailor the treatment to the particular needs of the process water system. For example, in a situation where very hard water is employed, additional hardness sequestering agent can be dispensed into the water by adding an additional separate pouch. In areas where the water is soft, a separate pouch with hardness sequestering agents may be unnecessary. Thus, the present invention enables one to have separate different treatment compositions in separate osmotic dispensing pouches. This also allows different sizes of pouches to be used, or, as shown in FIG. 3, osmotic pouches with smaller or larger exposed area of osmotic membrane, to alter the dispensing rate.

The present invention provides flexibility for providing treatment chemicals to different process water systems. This is accomplished with minimal capital expense, yet with relatively good control of the dispensing rate of the particular chemicals.

This has been a description of the present invention along with the preferred method of practicing the present invention. However, the invention itself should only be defined by the appended claims, WHEREIN

We claim:

1. A method of controlled dispensing treatment chemicals into a process water system comprising
placing a container of treatment chemicals in water in said system, said container having a dispensing port adapted to direct said treatment chemicals into said process water system, said container having a defined maximum internal volume;
said container having an exterior surface comprising an osmotic membrane;
wherein said membrane is placed in contact with said water permitting said water to pass through said membrane, thereby exceeding the maximum internal volume of said container forcing chemical from said container into said water system.

2. The method claimed in claim 1 wherein said process water system is one of a cooling tower, a chilled water system, a boiler, and a pulp and paper manufacturing process.

3. The method claimed in claim 2 wherein said osmotic membrane is placed in contact with water only when said system is in operation.

4. The method claimed in claim 3 wherein said membrane is supported beneath a spray of water, said spray of water moving only when said system is in operation.

5. The method claimed in claim 1 wherein a water soluble chemical is located in a first area adjoining said osmotic membrane, and said treatment chemical is located in a second area with a flexible partition between said first area and said second area, whereby dissolution of said water soluble chemical by water passing through said membrane causes said first area to expand, applying pressure on said second area forcing said treatment chemical from said container.

6. The method claimed in claim 1 wherein a plurality of containers are placed in said process water system.

7. A method of dispensing a chemical into a process water system wherein said chemical is held in an osmotically controlled container having an osmotic membrane adapted to transfer water into said container forcing said chemical from said container wherein said container is placed in a process water system and said osmotic membrane is contacted with water only while said process water system is in operation.

8. The method claimed in claim 7 wherein water is sprayed on said osmotic membrane when said process water system is in operation.

9. The method claimed in claim 7 wherein said process water system is a cooling tower and said container is positioned along a wall of said cooling tower.

10. The method claimed in claim 7 wherein said osmotic membrane is covered with a plurality of protective covers and a portion of said membrane is exposed by removing one or more of said covers.

11. A chemical dispenser comprising a liquid chemical housed in an inner compressible container, said first container having a dispensing valve;
a second container in fixed relation to said first container, said second container including a water soluble salt, said second container including an osmotic membrane adapted to permit water to pass through an exterior of said second container to an interior of said second container filling said second container and forcing liquid in said first container through said dispensing valve.

12. The chemical dispenser claimed in claim 11 wherein said second container is a rigid container which encases said first container.

13. The apparatus claimed in claim 11 wherein said second container comprises a flexible pouch attached to said first container wherein expansion of said second container applies pressure on said first container.

14. The apparatus claimed in claim 11 wherein said salt is sodium chloride.

15. The apparatus claimed in claim 11 wherein said osmotic membrane is covered with a plurality of covers whereby portions of said osmotic membranes can be selectively exposed by removing selected ones of said covers.

16. A chemical dispenser comprising a container incorporating a treatment chemical, an osmotic membrane on a surface of said container adapted to permit water to pass through from an exterior portion of said container to said interior portion of said container to force treatment chemical from said interior portion, said osmotic membrane covered with a plurality of covers each cover covering a portion of said osmotic membrane whereby removing a selected number of said plurality of covers exposes a selected portion of said osmotic membrane.
